(19) United States
(12) Patent Application Publication
(10) Pub. No.: US 2018/0356598 A1
(43) Pub. Date: Dec. 13, 2018

(54) Phase Adjustment Device for Two Light Waves

(71) Applicants: INTER-UNIVERSITY RESEARCH INSTITUTE CORPORATION, NATIONAL INSTITUTES OF NATURAL SCIENCES, Tokyo (JP); NATIONAL INSTITUTE OF INFORMATION AND COMMUNICATIONS TECHNOLOGY, Tokyo (JP)

(72) Inventors: Hitoshi KIUCHI, Tokyo (JP); Atsushi KANNO, Tokyo (JP); Tetsuya KAWANISHI, Tokyo (JP)

(21) Appl. No.: 16/001,951

(22) Filed: Jun. 7, 2018

(30) Foreign Application Priority Data
Jun. 8, 2017 (JP) 2017-113839

(51) Int. Cl. G02B 6/35; G01L 1/24; H04J 14/02; H04B 10/00; H04B 10/50; H04Q 11/00

(52) U.S. Cl. CPC G02B 6/3586; G01L 1/246; H04Q 11/0001; H04B 10/12; H04B 10/506; H04J 14/02

(57) ABSTRACT

To provide a method for performing phase control of coherent two light wave signals while maintaining coherence in the state of the light signal, and a device which realizes such a method, there is provided, as illustrated in FIG. 1, a phase adjustment device 1 for two light waves including: a two light wave source 3, a wavelength separator 5, a first phase modulator 7, and a second phase modulator 9, whereby coherent two light waves are used as input signals to perform wavelength separation of those input signals thereafter to control optical phases of the respective light signals thereafter to multiplex them by using a multiplexer 11, thus to be able to obtain an output signal of which optical phase has been adjusted.

### TECHNICAL FIELD

The present invention relates to a phase adjustment device for optical microwave signals of two light waves. More specifically, the present invention relates to a phase adjustment device for two light waves in which coherent two light waves are used as input signals to allow those input signals to subject to wavelength separation thereafter to control optical phases of respective light signals thereafter to multiplex those light signals to thereby to be able to obtain an output signal of which optical phase has been adjusted.

### BACKGROUND ART

In phased-array antennas for which high speed and flexible phase control is required, and the like, it is necessary to control phases of microwave signals as electric signals to be delivered to respective antenna elements in accordance with a desired synthetic beam direction. Ordinarily, such a phase control is performed with respect to microwave signals thus to control the signal phase as an electric signal by using a microwave signal phase shifter.

### PRIOR ART DOCUMENT

### Non-Patent Document

Non-Patent Document 1 Tomohiro Akiyama, “Beam control by light controlled phased array antenna using Spatial Light Modulator” The Institute of Electronics, Information and Communication Engineers Technical Report, MW2008-50, 2008/7

### SUMMARY OF THE INVENTION

### Technical Problem

However, microwave signal phase shifters are difficult to prepare as a frequency used becomes higher, and also difficult in complying with broadband and/or high speed phase control. On the other hand, optical microwave signals are easy to generate at a high frequency and in complying with high frequency and broadband. For this reason, if two light wave signals can be subjected to phase control on light signals, it will become possible to control, at a high speed and in a broadband, phases of microwave signals obtained by photoelectric conversion as a beat signal. In view of this, the present invention has an object to provide a method for performing phase control of particularly coherent two light wave signals while maintaining coherence in the state of the light signal, and a device which realizes such a method.

### Solution to Problem

The present invention is essentially based on the finding that coherent two light waves are used as input signals to allow those input signals to subject to wavelength separation thereafter to control optical phases of the respective light signals to multiplex those light signals so that an output signal of which optical phase has been adjusted can be obtained. The present invention is particularly based on such a finding to allow two light signals which have been separated to undergo phase modulation at the same time so that coherence can be maintained.

The present invention relates to a phase adjustment device 1 for two light waves.

This phase adjustment device for two light waves includes a two light wave source 3, a wavelength separator 5, a first phase modulator 7, and a second phase modulator 9. This device preferably further includes a multiplexer 11.

The two light wave source 3 is a light source configured for generating a first light signal and a second light signal, which are coherent signals having different wavelengths.

The wavelength separator 5 is an optical element or device for receiving the first light signal and the second light signal, which have been output from the two wave light source 3 to perform separation into the first light signal and the second light signal.

The first phase modulator 7 is an optical element for receiving the first light signal separated by the wavelength separator 5 to adjust the phase of the first light signal.

The second phase modulator 9 is an optical element for receiving the second light signal separated by the wavelength separator 5 to adjust the phase of the second light signal.

The multiplexer 11 is an optical element or device for multiplexing or combining the first light signal which has been output from the first phase modulator 7 and the second light signal which has been output from the second phase modulator 9.

Since the phase adjustment device for two light waves of the present invention has the above-described configuration, there may be employed, for example, such an approach to use coherent two light waves as input signals to allow those input signals to be subject to wavelength separation thereafter to control optical phases of the respective light signals thereafter to multiplex or combine those light signals so that an output signal of which optical phase has been adjusted can be obtained.

It is preferable that the above-described device is configured so that the first phase modulator 7, the second phase modulator 9 and the multiplexer 11 are provided on a single substrate.

The above-described device may further include a first waveguide 13, and a second waveguide 15.

The first waveguide 13 is a waveguide provided on a single substrate, which is configured for connecting the wavelength separator 5, the first phase modulator 7 and the multiplexer 11.

The second waveguide 15 is a waveguide provided on a single substrate, which is configured for connecting the wavelength separator 5, the second phase modulator 9 and the multiplexer 11.

It is to be noted that the first waveguide 13 and the second waveguide 15 are only required to perform transmission of light signals which have been output from the wavelength separator 5, and it is not required that the wavelength separator 5 is provided on the single substrate.

It is preferable that the first phase modulator 7 and the second phase modulator 9 may be constructed as a single phase modulator.

Since the phase adjustment device for two light waves of the present invention has the above-described configuration, optical phases of respective light signals which have been separated can be controlled at the same time, thereby making it possible to maintain coherence of two light signals. In addition, since the phases of light signals can be modulated by means of the respective phase modulators, it is possible to attain phase modulation at a low voltage and in a manner to comply with high speed and broadband.

It is preferable that the above-described device is such that the wavelength separator 5 is the Fiber Bragg Grating, the Array Waveguide Grating, or the LCOS (Liquid Crystal On Silicon) filter.

It is preferable that the above-described device further includes a radio transmitter 17 connected to the multiplexer 11. Since the radio transmitter 17 is provided, the above-described device can take out a radio signal as a beat signal of light signals thus to permit such a radio signal to be output. In this instance, there results the state where phases of two light signals serving as a beat signal have been controlled in advance.

The present invention also provides a phase adjustment method for two light waves.

This method is:

directed to a phase adjustment method for two light waves including:

a step of receiving a first light signal and a second light signal, which are coherent signals having different wavelengths, thus to perform separation into the first light signal and the second light signal;

a step of receiving the first light signal which has been separated thus to adjust a phase of the first light signal;

a step of receiving the second light signal which has been separated thus to adjust a phase of the second light signal; and

a step of multiplexing the first light signal of which phase has been adjusted and the second light signal of which phase has been adjusted.

A preferred example of this method is such that the step of adjusting the phase of the first light signal and the step of adjusting the phase of the second light signal are executed at the same time.

### Advantageous Effects

The present invention can provide a method for performing phase control of particularly coherent two light wave signals while maintaining coherence in the state of light signals, and a device which realizes such a method.

### BRIEF DESCRIPTION OF THE DRAWINGS

FIG. 1 is a conceptual diagram for explaining a phase adjustment device for two light waves of the present invention.

FIG. 2 is a conceptual diagram illustrating an example of a phase adjustment device for two light waves using the so-called nested-type Mach-Zehnder waveguide.

FIG. 3 is a conceptual diagram for explaining an example of wavelength separation using the Fiber Bragg Grating.

FIG. 4 is a conceptual diagram for explaining wavelength separation using the Array Waveguide Grating.

FIG. 5 is a conceptual diagram for explaining an example of wavelength separation using the LCOS filter.

FIG. 6 is a conceptual diagram of a multichannel type phase adjustment device for two light waves having a single wavelength separator.

FIG. 7 is a conceptual diagram of a multichannel type phase adjustment device for two light waves including wavelength separators with respect to respective light signals which have been split by means of splitters.

FIG. 8 is a conceptual diagram of a phase adjustment device for two light waves of the single channel configuration.

FIG. 9 is a conceptual diagram of a phase adjustment device for two light waves of the single channel amplitude control type configuration.

FIG. 10 is a conceptual diagram of a phase adjustment device for two light waves of the image rejection mixer (upper and lower side bands separation mixer) configuration.

FIG. 11 is a conceptual diagram of a phase adjustment device for two light waves of the image rejection mixer (upper and lower side bands separation mixer) configuration.

### DESCRIPTION OF PREFERRED EMBODIMENTS

A preferred embodiment for carrying out the present invention will now be described with reference to the attached drawings. It should be noted that the present invention is not limited to an embodiment which will be described below, but may also include an embodiment or embodiments that those persons skilled in the art have modified as occasion demands within an apparent scope from the following embodiment.

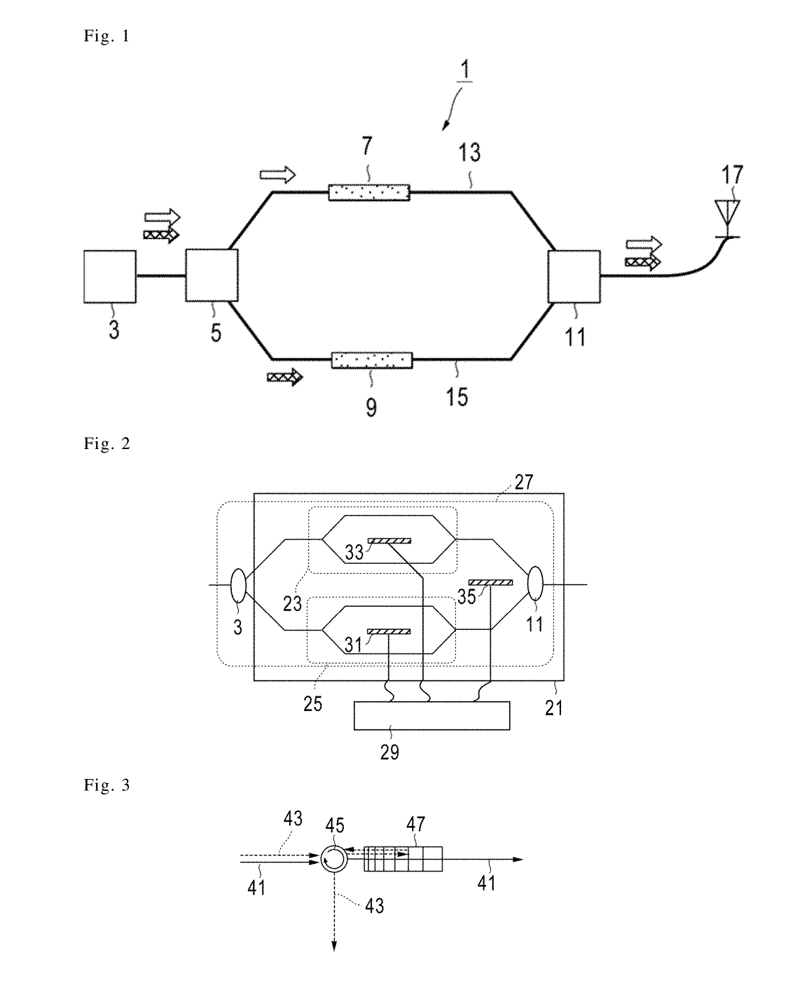

FIG. 1 is a conceptual diagram for explaining a phase adjustment device for two light waves of the present invention.

Such a phase adjustment device for two light waves is a device for adjusting phases of respective light signals in coherent two light signals having different frequencies while maintaining coherence of the two light signals.

As illustrated in FIG. 1, an example of this phase adjustment device 1 for two light waves includes two light wave source 3, wavelength separator 5, first phase modulator 7, second phase modulator 9, multiplexer 11, first waveguide 13, and second waveguide 15. The phase adjustment device for two light waves may employ, as occasion demands, the configuration that an optical device has in addition to the above. In addition, the phase adjustment device for two light waves may be connected to radio transmitter 17 so that it functions as a radio signal generator.

The two light wave source 3 is a light source for generating a first light signal and a second light signal which are coherent signals having different wavelengths. The first light signal and the second light signal may be included in a single signal while their wavelengths are different from each other. Namely, the first and second light signals may be pulse signals of the same timings. An example of a method of generating (or a method of acquiring) two light signals is a method using the Mach-Zehnder type optical modulator, or a method of extracting two light waves (by using, e.g., optical filter) from an optical comb generating apparatus. Such an optical comb generating apparatus is described in, e.g., JP2012-195792A, JP2011-221366A, and JP2006-030732A. An example of the frequency of the two light signals is more than 1 GHz and is less than 10 THz, may be 10 GHz and is less than 5 THz, and may be more than 50 GHz and is less than 1 THz.

The wavelength separator 5 is an optical element or device for receiving the first and second light signals which have been output from the two light wave source 3 to perform separation into the first and second light signals. An example of the wavelength separator 5 is the Fiber Bragg Grating, the Array Waveguide Grating (AWG), or the LCOS filter. Such optical elements may be combined, e.g., with an optical circulator so that separation into two light waves having different wavelengths can be performed. Moreover, the wavelength separating unit may have an optical filter which intensity-separates two light waves by using optical splitter such as coupler, etc. to allow one of two light waves to be transmitted therethrough (or to interrupt one light wave) with respect to the first light signal which has been separated, and an optical filter which allows the remainder of the two light waves to be transmitted therethrough (or interrupts the remainder) with respect to the remaining light signal which has been separated. An employment of such a configuration can frequency-separate the first and second light signals which have been output from the two light wave source 3.

The wavelength separation using the Fiber Bragg Grating (FBG) is described in, e.g., the JP4686785 and the JP5777140. As the Fiber Bragg Grating (FBG), there are mentioned the Uniform Fiber Grating, the Chirped Grating or Multi-section Grating, and the modulable Fiber Grating. Explanation will be given in connection with the FBG. The FBG may be obtained by irradiating ultraviolet rays through phase mask to change refractive index of the core thereof at a predetermined pitch. The waveform separation using the Array Waveguide Grating (AWG) is described in, e.g., the JP 5777140. The LCOS (Liquid Crystal On Silicon) filter is a reflection type spatial phase modulator in which liquid crystal elements (pixels) are arranged on the surface of CMOS.

The wavelength separation using the Fiber Bragg Grating (FBG) may be performed in a manner described below, for example. FIG. 3 is a conceptual diagram for explaining an example of the wavelength separation using the Fiber Bragg Grating. A first light signal (wavelength λ1) 41 and a second light signal (wavelength λ2) 43 are input to a circulator 45. These two signals which have been passed through the circulator 45 are input to the Fiber Bragg Grating (FBG) 47. It is to be noted that the circulator may be connected to waveguides or optical fibers so that the first and second light signals are input to the circulator therethrough. In this example, the first light signal 41 is turned back at a predetermined portion of the FBG. The first light signal 41 which has been turned back is returned to the circulator 45 so that it is guided to a predetermined direction. The circulator may be connected to waveguides or optical fibers: In that case, the first light signal 41 is output through the waveguide or the optical fiber. Further, the first light signal is optically connected to the first waveguide 13 on the substrate 21. On the other hand, in this example, the second light signal 43 is not reflected on the FBG, but is output as a transmitted light from the other end of the FGB so that it is optically connected to the second waveguide 15 on the substrate 21. In this case, the distance between the circulator 45 and the FBG 47, reflecting position of the first light signal within the FBG 47, the optical path length from the circulator 45 to the first waveguide 13, and the optical path length from the other end of the FBG 47 to the second waveguide 15 may be adjusted so that optical lengths between the first and second light signals 41 and 43 are equal to each other.

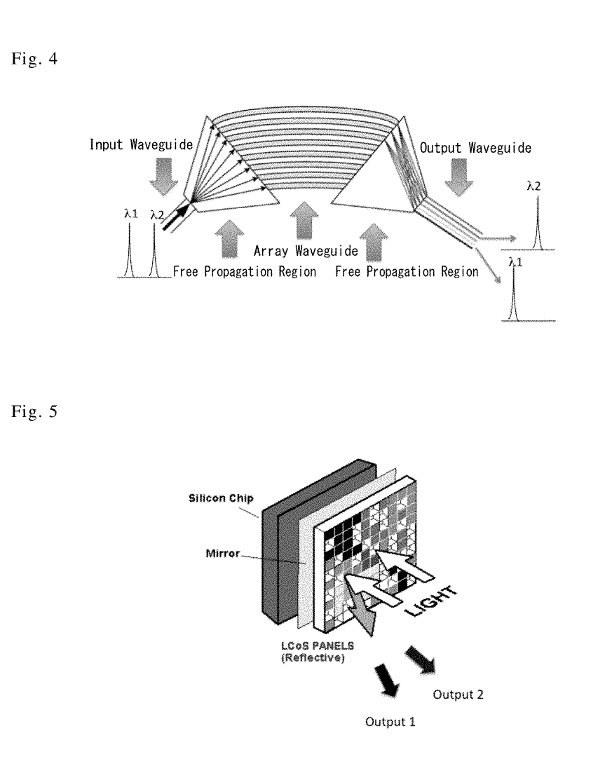

The wavelength separation using the Array Waveguide Grating (AWG) may be performed in a manner described below, for example. The AWG is known as disclosed in the JP-T2010-532877. FIG. 4 is a conceptual diagram for explaining wavelength separation using the Array Waveguide Grating. The AWG is composed of two free propagation regions and a plurality of array waveguides of which lengths are slightly different. Rays of light, which have been input, will be passed through a large number of propagation paths having different path lengths. At this time, any interference takes place at respective output optical waveguide input terminals located at the final stage. Only wavelengths with uniform optical phases are strengthen each other and are thus selected. By performing, with an optical switch, selection between two output optical guides of an output optical waveguide corresponding to the first light signal (light having a wavelength λ1) and an output optical waveguide corresponding to the second light signal (light having a wavelength λ2), it is possible to obtain the first light signal (light having wavelength λ1) and the second light signal (light having a wavelength λ2) which have been separated.

The wavelength separation using the LCOS filter may be carried out in a manner described below, for example. FIG. 5 is a conceptual diagram for explaining an example of the wavelength separation using the LCOS filter. The LCOS filter is of the reflection type in which liquid crystal elements (pixels) are arranged on the surface of the CMOS, and is configured so that two or more reflection output directions can be selected. Light input to the LCOS is separated in advance into spectra by means of gratings or prisms, etc., wherein optical wavelengths corresponding to respective pixels may be already known. The first light signal (light having wavelength λ1) and the second light signal (light having wavelength λ2) are reflected on a mirror after passed through the liquid crystal elements. At this time, output ports different from each other are selected. Any unnecessary wavelength component would be attenuated without being passed through the liquid crystal elements. Thus, it is possible to obtain the first light signal (light having wavelength λ1) and the second light signal (light having wavelength λ2), which have separated.

The first phase modulator 7 is an optical element for receiving the first light signal separated by the wavelength separator 5 thus to adjust the phase of the first light signal. The second phase modulator 9 is an optical element for receiving the second light signal separated by the wavelength separator 5 thus to adjust the phase of the second light signal. It is preferable that the first phase modulator 7 and the second phase modulator 9 are constructed as a single phase modulator. The phase modulator is also called a phase shifter. The first phase modulator 7 and the second phase modulator 9 may be respectively provided on the first waveguide 13 and the second waveguide 15. In this case, there may be configured a waveguide of the Mach-Zehnder type having the first and second waveguides as two arms. In order to maintain coherence of two light signals, it is preferable that, in the case where no voltage is applied to the respective electrodes, the first and second waveguides 13 and 15 are designed so that lengths of the waveguides are caused to be equal to each other. It is to be noted that this device is such that light signals having different wavelengths are scheduled to be propagated on two arms unlike the ordinary Mach-Zehnder type optical modulator. For this reason, the length of any one of the waveguides may be adjusted for the purpose of allowing the respective optical paths lengths to be the same. The waveguide is not in vacuum state, but has a refractive index. For this reason, there takes place any difference in light velocity in dependency upon the wavelength. In order that the first and second light signals which have been output from the wavelength separator 5 arrive at the multiplexer 5 at the same time, optical path lengths of the first and second light signals (, thus the lengths of the first and second waveguides 13 and 15) may be adjusted by using the relationship between refractive indices of the waveguides and the wavelengths of the first and second light signals. Particularly, in the case where the refractive indices of the waveguides and the wavelengths of the first and second light signals 13 and 15 are already known, there may be employed such a design to adjust the lengths of the first and second waveguides 13 and 15 in advance so that the first and second light signals which have been output from the wavelength separator 5 arrive at the multiplexer 11 at the same time.

In order to control phases of the first and second light signals respectively propagating on the first and second waveguides 13 and 15, one or two electrodes may be provided. In the case where two electrodes are provided for the purpose of controlling phases of the first and second light signals respectively propagating on the first and second waveguides 13 and 15, such two electrodes may be provided along respective predetermined portions of the first and second waveguides 13 and 15. By applying voltages onto the electrodes, voltages (e.g., DC voltages) applied to the first and second waveguides 13 and 15 are controlled, thereby making it possible to control phases of the first and second light signals respectively propagating on the first and second waveguides 13 and 15. By means of the phase modulator, it is possible to perform an equivalent microwave phase shifter operation corresponding to single channel.

The phase modulation of light signals propagating on two waveguides (or two arms) are known as described in, e.g., the JP5110459, the JP 5757557, the JP5777140, the JP5838532, and the JP6032699. For example, a bias voltage may be applied to an electrode extending in the middle of two waveguides thus to apply a voltage onto the two waveguides to thereby adjust phases with respect to respective light signals propagating on the two waveguides.

FIG. 2 is a conceptual diagram illustrating an example of the phase adjustment device for two light waves using the so-called nested Mach-Zehnder waveguide. In this example, on a single substrate (e.g., LN substrate), a first sub Mach-Zehnder waveguide 23 constituting the first phase modulator 7 is provided at first waveguide 13, and a second sub Mach-Zehnder waveguide 25 constituting the second phase modulator 9 is provided at the second waveguide 15. In other words, the first and second sub Mach-Zehnder waveguides 23 and 25 are respectively provided at the first and second waveguides 13 and 15 constituting two arms of a main Mach-Zehnder waveguide 27. In the example of FIG. 2, there exists a bias control unit 29 for generating bias voltages applied to the first and second sub Mach-Zehnder waveguides 23 and 25 and the main Mach-Zehnder waveguide 27. The bias control unit 29 is connected to a first bias electrode 33, a second bias electrode 35 and a third bias electrode 37 for applying bias voltages to the first and second sub Mach-Zehnder waveguides 23 and 25, and the main Mach-Zehnder waveguide 27, wherein the bias control unit 29 controls voltages applied to the respective bias electrodes 33, 35, 37, thereby making it possible to control respective phases of the first and second light signals. It is further to be noted, that, e.g., there may be a configuration such that no third bias electrode 37 exists, or a configuration such that only the first bias electrode 33 exists.

The sizes of the substrate are not particularly limited if it has sizes such that predetermined waveguides can be formed. An example of the long side of the substrate may be 1 cm to 10 cm, may be preferably 2 cm to 5 cm, and may be 2 cm to 4 cm. An example of the widths of respective waveguides is, e.g., 1 to 20 micrometers, and may be preferably 5 to 10 micrometers. In addition, an example of the depth (width) of the waveguide may be 1 to 20 micrometers, or 5 to 10 micrometers.

As described later, in the case where two light waves are demultiplexed, i.e., separated into a plurality of light waves by means of, e.g., demultiplexer, and phase modulation is performed with respect to the pair (set) of demultiplexed or separated respective two light waves, there is employed such an approach to control voltage values to be applied to the respective electrodes every channel, thereby making it possible to provide different equivalent microwave phase shift amounts. In this case, two light signals having different wavelengths which have been separated by means of the wavelength separator may be demultiplexed into a plurality of (N) light signals by means of the demultiplexer. In addition, two light signals may be demultiplexed into a plurality of (N) light signals by means of the demultiplexer to perform, by means of the wavelength separator, separation into two light signals having different wavelengths with respect to the respective demultiplexed plural (N) light signals.

The multiplexer 11 is an optical element for multiplexing the first light signal which has been output from the first phase modulator 7 and the second light signal which has been output from the second phase modulator 9. An example of the multiplexer 11 is a coupler. It is preferable that the first phase modulator 7, the second phase modulator 9 and the multiplexer 11 are provided on a single substrate. An example of the substrate is LiNbO₃ substrate (LN substrate). The first and second waveguides 13 and 15 are only required to perform transmission of light signals which have been output from the wavelength separator 5, but the wavelength separator 5 is not required to be provided on a single substrate.

Since the phase adjustment device for two light waves of the present invention has the above-described configuration, it is possible to control, at the same time, optical phases of respective light signals which have been separated. Thus, coherence of two light signals can be maintained. In addition, since the phase of the light signal can be modulated by means of the phase modulator, it is possible to attain the phase modulation at a low voltage and in a manner to comply with high speed and broadband.

It is preferable that the above-described device further includes a wire transmitter 17 connected to the multiplexer 11. Since the radio transmitter 17 is provided, the device can take out radio signals as a beat signal of light signals and output such radio signals. In this instance, there results the state where the phases of two light signals serving as a beat signal have been controlled. An example of the radio transmitter may include a photodetector, and an antenna. In the case where two light signals having different wavelengths are input to the photodetector as described in the JP3874119, and the JP3937237, an electric signal corresponding to a frequency difference therebetween is generated. This electric signal is sent to the antenna so that a radio signal can be obtained.

The photodetector is means for detecting an output light of a modulated light signal generator to convert it into an electric signal. As the photodetector, there may be employed any known photodetector. As the photodetector, a device including, e.g., photodiode may be employed. As the photodetector, there may be mentioned, e.g., a photodetector which detects a light signals to convert them into electric signals. By means of the photodetector, it is possible to detect intensity and frequency, etc. of the light signal. As such photodetector, e.g., there may be employed, as occasion demands, a photodetector described in ‘Hiroo Yonetsu “Optical Communication Device Engineering”—Light Emitting/Light Receiving Element —, Kogaku Tosho Kabusiki Kaisha, the 6-the Edition, published on 2000’. The antenna is a device for transmitting, as a radio signal, an electric signal converted by the photodetector. As such an antenna, there may be used a known antenna.

The present invention also provides a phase adjustment method for two light waves.

This method includes:

a step of allowing a wavelength separator 5 to receive a first light signal and a second light signal, which are coherent signals having different wavelengths, to perform separation into the first light signal and the second light signal;

a step of allowing a phase modulator to receive the separated first light signal to adjust a phase of the first light signal;

a step of allowing another or the phase modulator to receive the separated second light signal to adjust a phase of the second light signal; and

a step of allowing a multiplexer 11 to multiplex the first light signal of which phase has been adjusted and the second light signal of which phase has been adjusted.

In a preferred example of this method, the step of adjusting the phase of the first light signal and the step of adjusting the phase of the second light signal may be executed at the same time.

This method may further include a step of taking out radio signals as a beat signal of light signals. Namely, after the first light signal of which phase has been adjusted and the second light signal of which phase has been adjusted are multiplexed, a signal thus multiplexed is delivered to the photodetector so that a beat signal corresponding to a frequency difference between the first light signal and the second light signal is output as an electric signal. Further, the electric signal which has been output is delivered to the antenna, thereby making it possible to output a radio signal having a frequency corresponding to a frequency difference between the first light signal and the second light signal.

### EXAMPLES

### Example 1

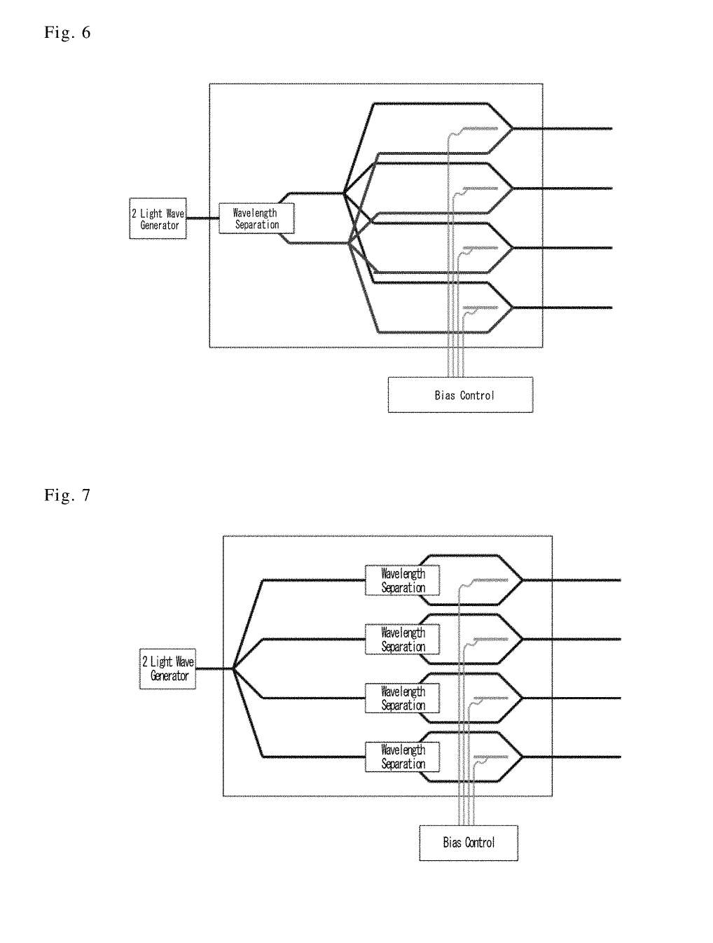

The Example 1 relates to a multichannel type phase adjustment device for two light waves having a single wavelength separator. FIG. 6 is a conceptual diagram of a multichannel type phase adjustment device for two light waves having a single wavelength separator. As illustrated in FIG. 6, this example allows two light signals having different wavelengths which have been generated by means of a two light wave generator to be subject to wavelength separation by means of the wavelength separator to perform separation into the first light signal and the second light signal. Further, the first and second light signals thus separated are respectively split by means of splitters (e.g., couplers). The sets of the first light signal and the second light signal which have been split are delivered to corresponding multiplexers. In this instance, respective sets form channels, and adjustment is made in advance such that lengths (or optical path lengths) of waveguides (from the wavelength separator to the multiplexers) of the first and second light signals are equal to each other in connection with the respective channels. Electrodes exist on respective channels, and voltages are applied to the electrodes so that phases of the first and second light signals on the respective channels are controlled. The first and second light signals which have been multiplexed at the multiplexers are output from the respective channels.

### Example 2

The Example 2 relates to a multichannel type phase adjustment device for two light waves including wavelength separators with respect to respective light signals which have been split by means of splitter. FIG. 7 is a conceptual diagram of the multichannel type phase adjustment device for two light waves including wavelength separators with respect to respective light signals which have been split by means of the splitter. As illustrated in FIG. 7, this example splits, by means of the splitter, two light signals having different wavelengths which have been generated by means of a two light wave generator. An example of the splitter is a coupler. Further, the wavelength separators respectively separate the respective light signals which have been split into first and second light signals. The wavelength separators respectively have corresponding multiplexers (e.g., couplers). The respective wavelength separators, and the first and second waveguides, the phase modulators and the multiplexers, which are connected to the wavelength separators constitute respective one channels. On the respective channels, there exist electrodes serving as respective elements of the phase modulators. Further, the respective electrodes are connected to a bias control unit. Thus, voltages are applied to the electrodes so that phases of the first and second light signals on the respective channels are controlled. The first and second light signals which have been multiplexed at the respective multiplexers are output from the respective channels.

### Example 3

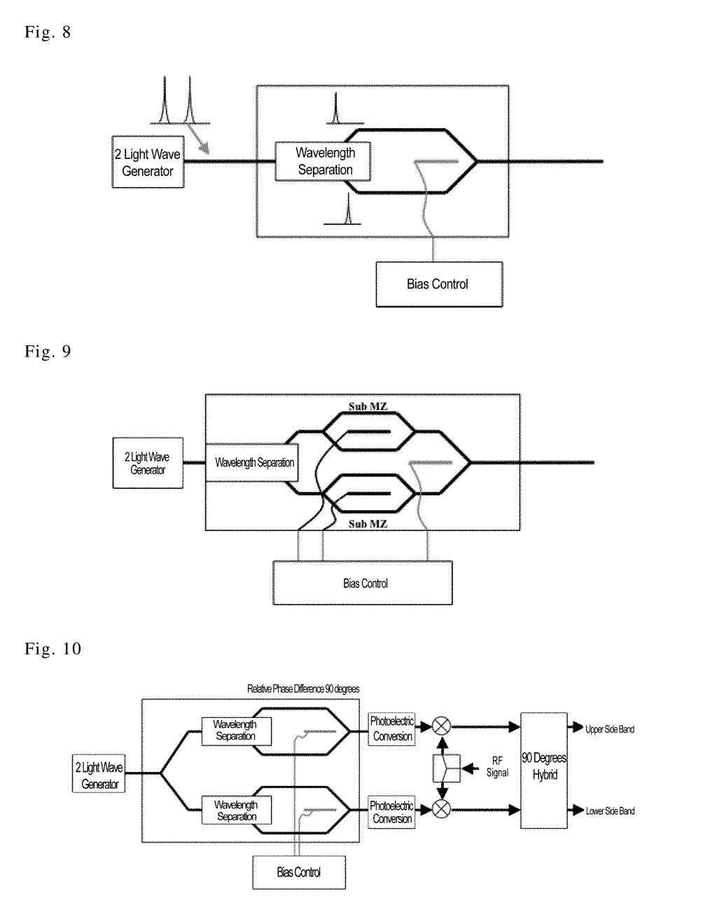

The Example 3 relates to a phase adjustment device for two light waves of the single channel configuration. FIG. 8 is a conceptual diagram of the phase adjustment device for two light waves of the single channel configuration. This example is basically similar to that of the phase adjustment device for two light waves illustrated in FIG. 1.

### Example 4

The example 4 relates to a phase adjustment device for two light waves of the single channel amplitude control type configuration. FIG. 9 is a conceptual diagram of the phase adjustment device for two light waves of the single channel amplitude control type configuration. This example is basically similar to that of the phase adjustment device for two light waves illustrated in FIG. 2.

### Example 5

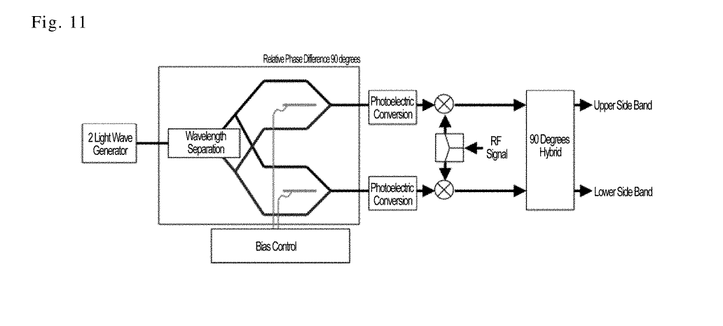

The Example 5 relates to a phase adjustment device for two light waves of the image rejection mixer (upper and lower side bands separation mixer) configuration. FIG. 10 is a conceptual diagram of the phase adjustment device for two light waves of the image rejection mixer (upper and lower side bands separation mixer) configuration. This device splits light signals by means of a splitter. Thereafter, wavelength separators allow respective light signals which have been split to be subject to wavelength separation into a first light signal and a second light signal. In the example of FIG. 10, there exist channels up to multiplexers with respect to the respective two wavelength separators. On the respective channels, phase modulators exist. Further, this device adjusts these two phase modulators to respectively output respective light signals in the state where the relative phase difference between light signals which are output from the two channels is 90 degrees (the state where the first and second light signals on the two channels are different in phase by 90 degrees relative to each other). Thus, outputs from the two channels are respectively delivered to photodetectors (photoelectric converters). Further, such two output signals are respectively converted into first and second electric signals at the photodetectors. The first electric signal and the second electric signal are mixed with a radio frequency signal (RF signal), and are delivered to a 90 degree hybrid coupler (circuit) in that state. Thus, an upper side band and a lower side band are output as two outputs from the 90 degree hybrid coupler.

### Example 6

The example 6 relates to a phase adjustment device for two light waves of the image rejection mixer (upper and lower side bands separation mixer) configuration. FIG. 11 is a conceptual diagram of the phase adjustment device for two light waves of the image rejection mixer (upper and lower band separation mixer) configuration. This device is separated into a first light signal and a second light signal by means of a wavelength separator. Further, the first and second light signals are respectively split by splitters. In the example of FIG. 11, there exist channels up to multiplexers with respect to respective two wavelength separators. On the respective channels, phase modulators exist. Further, this device adjusts the respective two phase modulators to respectively output respective light signals in the state where the relative phase difference between respective light signals which are output from the two channels is 90 degrees (the state where the first and second light signals on the two channels are different in phase by 90 degrees relative to each other). Thus, outputs from the respective two channels are respectively delivered to photodetectors (photoelectric converters). Further, those two output signals are respectively converted into first and second electric signals at the photodetectors. The first and second electric signals thus obtained are mixed with a radio frequency signal (RF signal), and are delivered to a 90 degree hybrid coupler (circuit) in that state. Thus, an upper side band and a lower side band are output as two outputs from the 90 degree hybrid coupler.

### INDUSTRIAL APPLICABILITY

The present invention can be utilized within the field of the optical information communications and/or radio communications.

### DESCRIPTION OF SIGNS

Phase adjustment device, 3 Two light wave source, 5 Wavelength separator, 7 First phase modulator, 9 Second phase modulator, 11 Multiplexer, 13 First waveguide, 15 Second waveguide 15, 17 Radio transmitter 17

What is claimed is:

1. A phase adjustment device for two light waves including:
a two light wave source (3) for generating a first light signal and a second light signal, which are coherent signals having different wavelengths;
a wavelength separator (5) which receives the first light signal and the second light signal, which have been output from the two light wave source (3), to perform separation into the first light signal and the second light signal;
a first phase modulator (7) which receives the first light signal separated by the wavelength separator (5) to adjust a phase of the first light signal; and
a second phase modulator (9) which receives the second light signal separated by the wavelength separator (5) to adjust a phase of the second light signal.

2. The device according to claim 1, further including:
a multiplexer (11) which multiplexes the first light signal which has been output from the first phase modulator (7), and the second light signal which has been output from the second phase modulator (9).

3. The device according to claim 2,
wherein the first phase modulator (7), the second phase modulator (9) and the multiplexer (11) are provided on a single substrate.

4. The device according to claim 3, including:
a first waveguide (13) which connects the wavelength separator (5), the first phase modulator (7) and the multiplexer (11); and
a second waveguide (15) which connects the wavelength separator (5), the second phase modulator (9) and the multiplexer (11),
wherein the first waveguide and the second waveguide have lengths equal to each other, and
wherein the first phase modulator (7) and the second phase modulator (9) are constructed as a single phase modulator.

5. The device according to claim 2,
wherein the wavelength separator (5) is the Fiber Bragg Grating, the Array Waveguide Grating, or the LCOS (Liquid Crystal On Silicon) filter.

6. The device according to claim 2, further including:
a radio transmitter (17) connected to the multiplexer (11).

7. A phase adjustment method for two light waves including:
a step of receiving a first light signal and a second light signal, which are coherent signals having different wavelengths, to perform separation into the first light signal and the second light signal;
a step of receiving the separated first light signal to adjust a phase of the first light signal;
a step of receiving the separated second light signal to adjust a phase of the second light signal; and
a step of multiplexing the first light signal of which phase has been adjusted and the second light signal of which phase has been adjusted.
